(19) United States
(12) Patent Application Publication
(10) Pub. No.: US 2023/0132482 A1
(43) Pub. Date: May 4, 2023

(54) METHOD AND DEVICE FOR REINFORCEMENT LEARNING

(71) Applicant: Robert Bosch GmbH, Stuttgart (DE)

(72) Inventors: Hamish Flynn, Stuttgart (DE); Jan Peters, Seeheim-Jugenheim (DE); Melih Kandemir, Odense (DK)

(21) Appl. No.: 18/046,564

(22) Filed: Oct. 14, 2022

(30) Foreign Application Priority Data
Oct. 29, 2021 (DE) 10 2021 212 277.9

(51) Int. Cl. G06N 20/00

(52) U.S. Cl. CPC G06N 20/00

(57) ABSTRACT

A device and method for reinforcement learning. The method includes providing parameters of a policy for reinforcement learning, determining a behavior policy depending on the policy, sampling a training data set with the behavior polic, and determining an update for the parameters with an objective function, wherein the objective function maps a difference between an estimate for an expected reward when following the policy and an estimate for a distance between the policy and the behavior policy, that depends on the policy and on the behavior policy, to the update. Or, the method includes providing distribution for parameters of a policy for reinforcement learning, determining a behavior policy depending on the policy, sampling a training data set with the behavior policy, and determining an update for the distribution with another objective function.

### CROSS REFERENCE

The present application claims the benefit under 35 U.S.C. § 119 of German Patent Application No. DE 10 2021 212 277.9 filed on Oct. 29, 2021, which is expressly incorporated herein by reference in its entirety.

### BACKGROUND INFORMATION

The present invention relates to a device, a computer program and a computer-implemented method for machine learning.

“Relative Entropy Policy Search,” by Jan Peters, Katharina Mülling, Yasemin Altung, in Proceedings of the Twenty-Fourth AAAI Conference on Artificial Intelligence (AAAI-10), 2010 describe aspects of Relative Entropy Policy Search.

### SUMMARY

According to an example embodiment of the present invention, a method for reinforcement learning comprises providing parameters of a policy for reinforcement learning, determining a behavior policy depending on the policy, sampling a training data set with the behavior polic, and determining an update for the parameters with an objective function, wherein the objective function maps a difference between an estimate for an expected reward when following the policy and an estimate for a distance between the policy and the behavior policy, that depends on the policy and on the behavior policy, to the update or wherein the method comprises providing distribution for parameters of a policy for reinforcement learning, determining a behavior policy depending on the policy, sampling a training data set with the behavior policy, and determining an update for the distribution with an objective function, wherein the objective function maps a difference between an expectancy value for an estimate for an expected reward when following the policy and an expectancy value for an estimate for a distance between the policy and the behavior policy, that depends on the policy and on the behavior policy, to the update. This way, it is not necessary to determine a closed-form solution to a Relative Entropy Policy Search problem. The updated policy is instead found by optimizing an objective function that corresponds to a lower bound that can be computed from training data.

According to an example embodiment of the present invention, the method may comprise determinig the update for the distribution depending on the distribution that result in a value of the objective function that is larger than a value of the objective function that results for at least one other distribution. This way, the policy is found by optimizing the objective function regarding the distribution of the parameters of the policy.

Preferably, the method comprises determinig the update for the distribution depending on the distribution that maximize the value of the objective function.

According to an example embodiment of the present invention, the method may comprise providing a reference distribution over the parameter values, and providing a confidence parameter, wherein the objective function comprises a term that depends on a sum of the confidence parameter and a Kullback-Leibler divergence between the distribution and the reference distribution. This term accounts for an uncertainty that arises from estimating the expected reward using the training data set.

According to an example embodiment of the present invention, the method may comprise sampling parameters from the reference distribution or from the distribution, and determining the behavior policy depending on the parameter values that are sampled from the distribution. This way, the policy is found by optimizing the objective function regarding the parameters that define the distribution. The parameters of the policy are derivable from the distribution afterwards.

According to an example embodiment of the present invention, the method may comprise determining the parameter values that result in a value of the objective function that is larger than a value of the objective function that results for other parameter values. This way, the policy is found by optimizing the objective function regarding the parameters of the policy.

Preferably, the method comprises determining the parameter values that maximize the value of the objective function.

According to an example embodiment of the present invention, the method may comprise determining the behavior policy depending on initial parameter values or depending on the parameter values.

According to an example embodiment of the present invention, the method may comprise determining the policy depending on the parameter values or determining the distribution and sampling the paramters of the policy from the distribution.

According to an example embodiment of the present invention, the method may comprise receiving input data and determining output data from the input data with the policy.

According to an example embodiment of the present invention, a device for reinforcement learning is configured, in particular with an input and an output and at least one processor and at least one storage, for executing steps in the method(a) disclosed herein.

According to an example embodiment of the present invention, a computer program that comprises computer-readable instructions, that when executed on a computer, cause the computer to perform the method(s) disclosed herein.

Further advantageous embodiments of the present invention are derivable from the following description and the figures.

### BRIEF DESCRIPTION OF THE DRAWINGS

FIG. 1 schematically depicts a part of a device for reinforcement learning, according to an example embodiment of the present invention.

FIG. 2 depicts steps in a first example embodiment of a method for reinforcement learning, according to the present invention.

FIG. 3 depicts steps in a second example embodiment of the method for reinforcement learning, according to the present invention.

### DETAILED DESCRIPTION OF EXAMPLE EMBODIMENTS

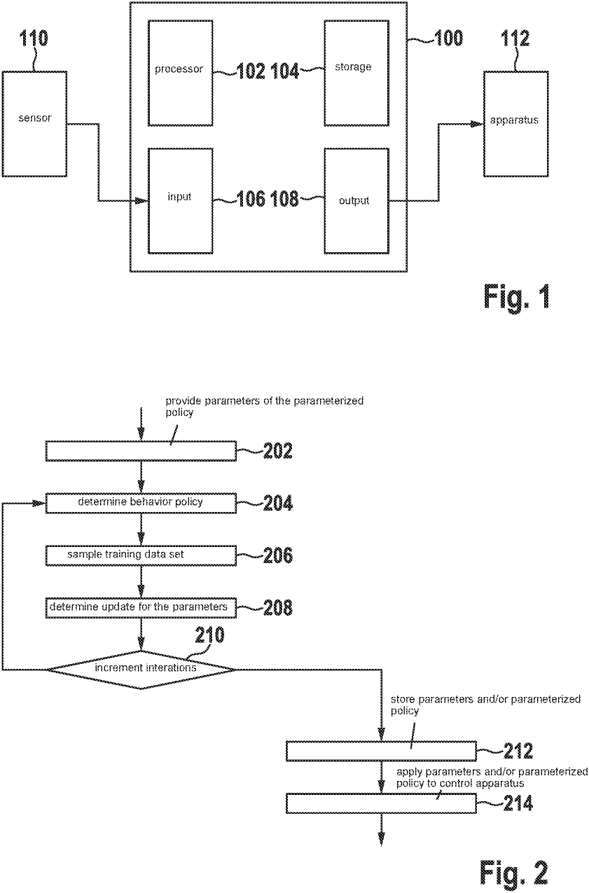

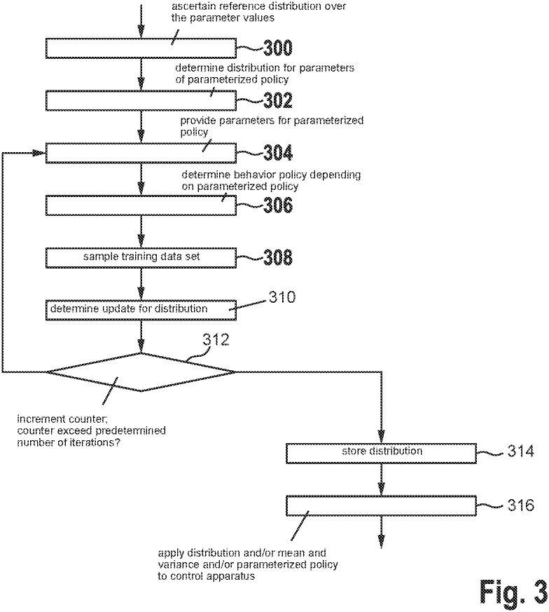

FIG. 1 depicts schematically a part of a device 100 for reinforcement learning. The device 100 comprises at least one processor 102 and at least one storage 104. The at least one storage 104 may store a computer program that comprises computer-readable instructions, that when executed on a computer, cause the computer to perform a method that will be described below with reference to FIG. 2 and FIG. 3. The device 100 is configured for executing steps in the method, in particular when the at least one processor 102 executes instructions of the computer program.

The device 100 in the example comprises an input 106 and an output 108. The input 106 is configured for receiving input data. The output 108 is configured to output output data.

The input 106 may be configured for receiving the input data from a sensor 110. The sensor 110 may comprise a camera or a microphone. The input data may comprise at least one of digital images, e.g. video, radar, LiDAR, ultrasonic, motion, thermal images, sonar, or digital audio signals.

The device 100 may be configured for detecting anomalies in the input data, classifying the input data, detecting a presence of objects in the input data or performing a semantic segmentation on the input data, e.g., regarding traffic signs, road surfaces, pedestrians, vehicles.

The device 100 may be configured for controlling an apparatus 112. The apparatus 112 may be a vehicle or a robot. The device 100 may be configured for controlling the apparatus 112 depending on whether an anomaly is detected in the input data or not. The device 100 may be configured for controlling the apparatus 112 depending on a classification of the input data. The device 100 may be configured for controlling the apparatus 112 depending on whether the presence of an object is detected in the input data or not. The device 100 may be configured for controlling the apparatus 112 depending on a result of the semantic segmentation on the input data.

The method applies to contextual bandit problems. Input data classification and detecting anomalies may be framed as a contextual bandit problem. The method applies to other problems as well that are represented as contextual bandit problems.

A contextual bandit problem is defined by a set of states S, a set of actions A, an unknown initial state distribution µ over S and an unknown stochastic reward function ρ : S × A → M([0, 1]), wherin M([0,1]) denotes a set of all probability distributions over the interval [0; 1], µ(s) denotes a probability mass or probability density of a state s ∈ S under the initial state distribution, and ρ(r|s,a) denotes the probability mass or probability density of a reward r ∈ [0; 1] conditioned on the state s ∈ S and an action a ∈ A.

A policy π: S → M(A) is a function that maps states to distributions over actions.

The contextual bandit problem considered herein comprises parametric policies π_{θ} : S × Θ → M(A), wherein Θ is some set of possible values that the parameter θ can take. The goal of the contextual bandit problem is to find the policy parameters θ that maximize an expected reward:

$$J \left({π}_{θ}\right) = {s ∼ μ \left(s\right)}_{} {a ∼ μ \left(a \left|s\right)\right)}_{} {r ∼ μ \left(r \left|s , a\right)\right)}_{} \left[r\right]$$

The method trains the device 100. The method may train the device 100 in particular for detecting anomalies in the input data, classifying the input data, detecting the presence of objects in the input data or performing the semantic segmentation on the input data.

Since µ and ρ are unknown, neither J(π_{θ}) nor its gradient with respect to θ are computable. Thus, the expected reward or its gradient is estimated with a training data set D =

$${\left\{{s}_{i} , {a}_{i} , {r}_{i}\right\}}_{i = 1}^{n}$$

containing state, action and reward triples, where the states

$${\left\{{s}_{i}\right\}}_{i = 1}^{n}$$

are sampled independently from µ, the actions

$${\left\{{a}_{i}\right\}}_{i = 1}^{n}$$

are sampled independently from a known behavior policy b with a probability density b(s|a) and the rewards

$${\left\{{r}_{i}\right\}}_{i = 1}^{n}$$

are sampled independently from the reward distribution ρ.

The method comprises computing a lower bound on J(π_{θ}). The lower bound in the example can be computed using only the training data set D.

The method comprises using this lower bound as an objective function, since maximizing a lower bound on the expected reward provides a policy π_{θ} that has a high expected reward.

Below, two embodiments of the method are described.

A first embodiment is described referencing FIG. 2.

The first embodiment of the method for reinforcement learning comprises a step 202.

In the step 202, parameters θ of the parameterized policy π_{θ} for reinforcement learning are provided. In the example, a predetermined number of iterations I is provided and a counter i for counting the iterations is initialized e.g. i=0.

Afterwards a step 204 is executed.

In step 204, the behavior policy b is determined depending on the parameterized policy π_{θ}.

Afterwards a step 206 is executed.

In the step 206, the training data set D is sampled with the behavior policy b.

Afterwards a step 208 is executed.

In the step 208, an update for the parameters θ is determined with the objective function J(θ) according to the first embodiment.

The method may comprise determining the parameter values θ that result in a value of the objective function J(θ) according to the first embodiment that is larger than a value of the objective function J(θ) according to the first embodiment that results for other parameter values.

The method may comprise determining the parameter values θ that result in a value of the objective function J(θ) that maximizes the value of the objective function (J(θ) according to the first embodiment.

Afterwards, a step 210 is executed.

In the step 210 the counter i for the iterations is incremented, e.g. i=i+1, and it is determined, whether the counter i exceeds the predetermined number of iterations I or not.

When the counter i exceeds the predetermined number of iteration I, a step 212 is executed. Otherwise the step 204 is executed.

In the step 212, the parameters θ and/or the parameterized policy π_{θ} may be stored.

The training for reinforcement learning comprises the steps 202 to 212. The result of this training is the parameterized policy π_{θ} and/or the parameters θ that result in the final iteration.

Optionally, a step 214 may be executed afterwards. In the step 214, the parameters θ and/or the parameterized policy π_{θ} may be applied to control the apparatus 112.

Controlling the apparatus 112 may comprise receiving input data, processing the input data according to the parameterized policy π_{θ} that results from the final iteration, and outputting output data to control the apparatus 112 that results from processing the input data with this parameterized policy π_{θ}.

The apparatus 112 may be controlled depending on whether an anomaly is detected in the input data or not with this parameterized policy π_{θ}. The apparatus 112 may be controlled depending on a classification of the input data with this parameterized policy π_{θ}. The apparatus 112 may be controlled depending on whether the presence of an object is detected in the input data or not with this parameterized policy π_{θ}. The apparatus 112 may be controlled depending on a result of the semantic segmentation on the input data with this parameterized policy π_{θ}.

The objective function J(θ) maps a difference between an estimate for an expected reward Ĵ^{(sg)}(π_{θ},b,D) when following the parameterized policy π_{θ} and an estimate D̂(π_{θ},b,D) for a distance D_{TV}((µ,π_{θ})∥ (µ,b)) between the policy π_{θ} and the behavior policy b to the update for the parameters θ.

The expected reward Ĵ^{(sg)}(π_{θ},b,D) may be

$${\hat{J}}^{\left(s , g\right)} \left({π}_{θ} , b , D\right) = \frac{1}{n} {\sum }_{i = 1}^{n} \frac{{π}_{θ} \left({a}_{i} \left|{s}_{i}\right)\right)}{{\left[{π}_{θ} \left({a}_{i} \left|{s}_{i}\right)\right)\right]}_{s g}} {r}_{i}$$

wherein [·]_{sg} is a stop gradient operator. This means the term [π_{θ}(aᵢ|sᵢ)]_{sg} is not considered when determining a gradient of the expected reward Ĵ^{(sg)}(π_{θ},b,D).

The estimate for the distance D̂(π_{θ},b,D) may be

$$\hat{D} \left({π}_{θ} , b , D\right) = \frac{1}{n} {\sum }_{i = 1}^{n} {D}_{T V} \left({π}_{θ} \left(⋅ \left|{s}_{i}\right)\right) \vert \vert b \left(⋅ \left|{s}_{i}\right)\right)\right)$$

wherein D_{TV}(π_{θ}(·|sᵢ)∥b(·|sᵢ)) is an estimate for a distance D_{TV}((µ,π_{θ})∥ (µ,b)) that depends on the policy π_{θ} and on the behavior policy b, and wherein D_{TV}((µ,π_{θ})∥ (µ,b)) is a total variation distance.

The objective function J(θ) according to the first embodiment is for example

$$J \left(θ\right) = {\hat{J}}^{\left(s g\right)} \left({π}_{θ} , b , D\right) - \hat{D} \left({π}_{θ} , b , D\right) .$$

The update for the parameters θ may be determined iteratively. In the example, the objective function J(θ) according to the first embodiment may be maximized iteratively with respect to the parameters θ using gradient ascent or some variant of gradient ascent, e.g. Adam optimization.

The update for the parameters θ may be determined in k steps with a learning rate α.

An exemplary algorithm for implementing the method according to the first embodiment is:

Input: Initial parameters θ, learning rate α

for iteration i=1,2, ... do

Set behavior policy b←π_{θ}

Sample

$$D = {\left\{{s}_{i} , {a}_{i} , {r}_{i}\right\}}_{i = 1}^{n}$$

using b

for step = 1, 2, ..., k do

$$θ ← θ + α {∇}_{θ} J \left(θ\right)$$

end for

end for

A second embodiment is described referencing FIG. 3.

The second embodiment of the method for reinforcement learning comprises a step 300.

In the step 300 a reference distribution P over the parameter values θ.

The reference distribution P may come from a parametric family of distributions, e.g. normal distributions. The reference distribution P may be

$$P = N \left({μ}_{P} , {σ}_{P}^{2} I\right)$$

wherein µ_{P} denotes the mean and

$${σ}_{P}^{2}$$

denotes the variance of the reference distribution P and I denotes the identity matrix. This means, the distribution P is a diagnoal normal distribution.

Afterwards a step 302 is executed.

In the step 302, a distribution Q for parameters θ of the parameterized policy π_{θ} is determined. The distribution Q may come from a parametric family of distributions, e.g. normal distributions. The distribution Q may be

$$Q = \left({μ}_{Q} , {σ}_{Q}^{2} I\right)$$

wherein µ_{Q} denotes the mean and

$${σ}_{Q}^{2}$$

denotes the variance of the distribution Q and I denotes the identity matrix. This means the distribution Q is a diagnoal normal distribution.

The mean µ_{Q} may be initialized with µ_{Q} ← µ_{P}.

The variance

$${σ}_{Q}^{2}$$

may be initialized with

$${σ}_{Q}^{2} ← {σ}_{P}^{2} ⋅$$

In the example, a predetermined number of iterations I is provided and a counter i for counting the iterations is initialized e.g. i=0.

Afterwards a step 304 is executed.

In the step 304, parameters θ of the parameterized policy π_{θ} for reinforcement learning are provided. In the example, the parameters θ are sampled from the distribution Q.

Afterwards a step 306 is executed.

In step 306 the behavior policy b is determined depending on the parameterized policy π_{θ}.

Afterwards a step 308 is executed.

In the step 308, the training data set D is sampled with the behavior policy b.

Afterwards a step 310 is executed.

In the step 310, an update for distribution Q is determined with the objective function J(Q) according to the second embodiment.

The method may comprise determining the distribution Q that result in a value of the objective function J(Q) according to the second embodiment that is larger than a value of the objective function J(Q) according to the second embodiment that results for other distributions Q.

In the example, the mean µ_{Q} and the variance

$${σ}_{Q}^{2}$$

that result in the value of the objective function J(Q) being larger than at least one other value of the objective function J(Q) that results for another mean and/or variance is determined.

The method may comprise determining the distribution Q that result in a value of the objective function J(Q) that maximizes the value of the objective function J(Q) according to the second embodiment.

In the example, the mean µ_{Q} and the variance

$${σ}_{Q}^{2}$$

that maximize the objective function J(Q) are determined.

Afterwards, a step 312 is executed.

In the step 312 the counter i for the iterations is incremented, e.g. i=i+1, and it is determined, whether the counter i exceeds the predetermined number of iterations I or not.

When the counter i exceeds the predetermined number of iteration I, a step 314 is executed. Otherwise, the step 304 is executed.

In the step 314, the distribution Q may be stored In the example, the mean µ_{Q} and the variance

$${σ}_{Q}^{2}$$

may be stored.

The training for reinforcement learning comprises the steps 300 to 314. The result of this training is the distribution Q and/or the mean µ_{Q} and the variance

$${σ}_{Q}^{2}$$

that allows sampling the parameterized policy π_{θ} and/or the parameters θ.

Optionally, a step 316 may be executed afterwards. In the step 316, the distribution Q and/or the mean µ_{Q} and the variance

$${σ}_{Q}^{2}$$

and/or the parameterized policy π_{θ} may be applied to control the apparatus 112.

Controlling the apparatus 112 may comprise receiving input data, processing the input data according to the parameterized policy π_{θ} that results from sampling from the distribution Q that is determined in the final iteration, and outputting output data to control the appratus 112 that results from processing the input data with this parameterized policy π_{θ}.

The apparatus 112 may be controlled depending on whether an anomaly is detected in the input data or not with this parameterized policy π_{θ}. The apparatus 112 may be controlled depending on a classification of the input data with this parameterized policy π_{θ}. The apparatus 112 may be controlled depending on whether the presence of an object is detected in the input data or not with this parameterized policy π_{θ}. The apparatus 112 may be controlled depending on a result of the semantic segmentation on the input data with this parameterized policy π_{θ}.

The objective function J(Q) according to the second embodiment maps a difference between an expectancy value Ĵ^{(sg)}(Q,b,D) for the estimate Ĵ^{(sg)}(π_{θ},b,D) for the expected reward when following the parameterized policy π_{θ} and an expectancy value D̂(Q,b,D) for the estimate D̂(π_{θ},b,D) to the update for the distribution Q.

The objective function J(Q) comprises a term

$$2 \sqrt{\frac{{D}_{K L} \left(Q \left|\text{}\right| P\right) + l n \left(2 \sqrt{n} / δ\right)}{2 n}}$$

that depends on a sum of a confidence parameter

$$ln \left(2 \sqrt{n} / δ\right)$$

and a Kullback-Leibler divergence D_{KL}(Q∥P) between the distribution Q and the reference distribution P.

The confidence parameter

$$ln \left(2 \sqrt{n} / δ\right)$$

in the example depends on a parameter δ ∈ (0,1]. This parameter δ is provided e.g. in an initialization.

This term accounts for an uncertainty that arises from estimating the expected reward using the training data set D

The expectancy value Ĵ^{(sg)}(Q,b,D) for the estimate Ĵ^{(sg)}(π_{θ},b,D) for the expected reward may be

$${\hat{J}}^{\left(s g\right)} \left(Q , b , D\right) = {E}_{θ ∼ Q} \left({\hat{J}}^{\left(s g\right)} \left({π}_{θ} , b , D\right)\right)$$

The expectancy value D(Q,b,D) for the estimate D̂(π_{θ},b,D) for the distance D_{TV}((µ,π_{θ})∥ (µ,b)) between the policy π_{θ} and the behavior policy b may be

$$\hat{D} \left(Q , b , D\right) = {E}_{θ ∼ Q} \left(\hat{D} \left({π}_{θ} , b , D\right)\right)$$

The objective function J(Q) according to the second embodiment is for example

$$J \left(Q\right) = {\hat{J}}^{\left(s g\right)} \left(Q , b , D\right) - \hat{D} \left(Q , b , D\right) - 2 \sqrt{\frac{{D}_{K L} \left(Q \left|\right| P\right) + ln \left(2 \sqrt{n} / δ\right)}{2 n}} .$$

The update for the distribution Q may be determined in k steps with a learning rate α.

An exemplary algorithm for implementing the method according to the first first embodiment is:

Input: Prior parameter distribution

$$P = N \left({μ}_{P} , {σ}_{P}^{2} I\right) ,$$

learning rate α

Initialise posterior mean µ_{Q} ← µ_{P} and variance

$${σ}_{Q}^{2} ← {σ}_{P}^{2} \cdot$$

for iteration i=1,2, ... do

Sample θ from

$$Q = N \left({\text{μ}}_{Q} , {σ}_{Q}^{2} I\right)$$

Set behavior policy b ← π_{θ}

Sample

$$D = {\left\{{s}_{i} , {a}_{i} , {r}_{i}\right\}}_{i = 1}^{n}$$

using b

for step = 1, 2, ..., k do

$${\text{μ}}_{Q} ← {\text{μ}}_{Q} + α {∇}_{{\text{μ}}_{Q}} J \left(Q\right)$$

$${σ}_{Q}^{2} ← {σ}_{Q}^{2} + α {∇}_{{σ}_{Q}^{2}} J \left(Q\right)$$

end for

Update prior mean µ_{P} ← µ_{Q}

end for

What is claimed is:

1. A method for reinforcement learning, wherein the method comprises the following steps:
providing parameters of a policy for reinforcement learning;
determining a behavior policy depending on the policy;
sampling a training data set with the behavior policy; and
determining an update for the parameters with an objective function;
wherein the objective function maps a difference between an estimate for an expected reward when following the policy and an estimate for a distance between the policy and the behavior policy, that depends on the policy and on the behavior policy, to the update, or
wherein the method comprises the following steps:
providing a distribution for parameters of a policy for reinforcement learning;
determining a behavior policy depending on the policy,
sampling a training data set with the behaviour policy; and
determining an update for the distribution with an objective function;
wherein the objective function maps a difference between an expectancy value for an estimate for an expected reward when following the policy and an expectancy value for an estimate for a distance between the policy and the behavior policy, that depends on the policy and on the behavior policy, to the update.

2. The method according to claim 1, wherein the method further comprises determining the update for the distribution depending on a distribution that results in a value of the objective function that is larger than a value of the objective function that results for at least one other distribution.

3. The method according to claim 2, wherein the method further comprises determining the update for the distribution depending on the distribution that maximizes the value of the objective function.

4. The method according to claim 1, wherein the method further comprises providing a reference distribution over the parameter values, and providing a confidence parameter, wherein the objective function includes a term that depends on a sum of the confidence parameter and a Kullback-Leibler divergence between the distribution and the reference distribution.

5. The method according to claim 4, wherein the method further comprises sampling parameters from the reference distribution or from the distribution, and determining the behavior policy depending on the parameter values that are sampled from the distribution.

6. The method according to claim 1, wherein the method further comprises determining parameter values that result in a value of the objective function that is larger than a value of the objective function that results for other parameter values.

7. The method according to claim 6, wherein the method further comprises determining the parameter values that maximize the value of the objective function.

8. The method according to claim 1, wherein the method further comprises determining the behavior policy depending on initial parameter values or depending on the parameter values.

9. The method according to claim 1, wherein the method comprises determining the policy depending on the parameter values or determining the distribution and sampling the paramters of the policy from the distribution.

10. The method according to claim 9, wherein the method comprises receiving input data and determining output data from the input data with the policy, for controlling an apparatus.

11. A device for reinforcement learning, the device comprising:
an input;
an output;
at least one processor; and
at least one storage;
wherein the device is configured to:
(i) :
provide parameters of a policy for reinforcement learning,
determine a behavior policy depending on the policy,
sample a training data set with the behavior policy, and
determine an update for the parameters with an objective function,
wherein the objective function maps a difference between an estimate for an expected reward when following the policy and an estimate for a distance between the policy and the behavior policy, that depends on the policy and on the behavior policy, to the update, or
(ii) :
provide a distribution for parameters of a policy for reinforcement learning; determining a behavior policy depending on the policy,
sample a training data set with the behaviour policy; and
determine an update for the distribution with an objective function;
wherein the objective function maps a difference between an expectancy value for an estimate for an expected reward when following the policy and an expectancy value for an estimate for a distance between the policy and the behavior policy, that depends on the policy and on the behavior policy, to the update.

12. A non-transitory computer-readable medium on which is stored a computer program including computer-readable instructions for reinforcement learning,
wherein the instructions, when executed by a processor, causing the processor to perform the following steps:
providing parameters of a policy for reinforcement learning;
determining a behavior policy depending on the policy;
sampling a training data set with the behavior policy; and
determining an update for the parameters with an objective function;
wherein the objective function maps a difference between an estimate for an expected reward when following the policy and an estimate for a distance between the policy and the behavior policy, that depends on the policy and on the behavior policy, to the update, or
wherein the instructions, when executed by the processor, causing the processor to perform the following steps:
providing a distribution for parameters of a policy for reinforcement learning;
determining a behavior policy depending on the policy,
sampling a training data set with the behaviour policy; and
determining an update for the distribution with an objective function;
wherein the objective function maps a difference between an expectancy value for an estimate for an expected reward when following the policy and an expectancy value for an estimate for a distance between the policy and the behavior policy, that depends on the policy and on the behavior policy, to the update.
